(19) United States
(12) Patent Application Publication
(10) Pub. No.: US 2008/0143901 A1
(43) Pub. Date: Jun. 19, 2008

(54) LIQUID CRYSTAL DISPLAY DEVICE AND METHOD OF DRIVING THE SAME

(76) Inventor: Dong-Gyu Kim, Yongin-si (KR)

Correspondence Address: F. CHAU & ASSOCIATES, LLC, 130 WOODBURY ROAD, WOODBURY, NY, 11797, US

(21) Appl. No.: 11/958,526

(22) Filed: Dec. 18, 2007

(30) Foreign Application Priority Data
Dec. 18, 2006 (KR) 10-2006-0129451

(51) Int. Cl. G02F 1/1343

(52) U.S. Cl. 349/38

(57) ABSTRACT

A patterned vertical alignment (PVA) liquid crystal display (LCD) device that provides a wide viewing angle, a high aperture ratio, and an improved visibility, and a method of driving the same, wherein the LCD device includes an LCD panel and a panel driver. The LCD panel includes a first substrate having first and second pixel electrodes formed in a sub-pixel area, first and second thin film transistors connected to the first and second pixel electrodes, respectively, first and second storage capacitors electrically connected to the first and second pixel electrodes, respectively, first and second gate lines connected to the first and second thin film transistors, respectively, and a data line commonly connected to the first and second transistors, and a second substrate facing the first substrate and having a common electrode. The panel driver includes a storage voltage supply unit supplying voltages having phases inverted with respect to each other to the first and second storage capacitors.

### CROSS-REFERENCE TO RELATED APPLICATION

This application claims priority from and the benefit of Korean Patent Application No. 10-2006-0129451, filed on Dec. 18, 2006 in the Korean Intellectual Property Office, the disclosure of which is incorporated herein by reference in its entirety.

### BACKGROUND OF THE INVENTION

1. Technical Field

The present disclosure relates to a liquid crystal display (“LCD”) device and, more particularly, to an LCD device that provides a wide viewing angle, a high aperture ratio, and an improved visibility, as well as a method of driving the same.

2. Discussion of Related Art

A liquid crystal display (“LCD”) device displays an image by driving liquid crystal molecules according to an electric field to control the light transmissivity of the liquid crystal molecules. The LCD device includes an LCD panel displaying an image through a liquid crystal cell matrix and a driving circuit for driving the liquid crystal panel. Such LCD devices are equipped with wide-viewing angle technology to overcome the typical narrow viewing angle in which an image is seen to be distorted when viewed from the side, that is, at a narrow angle.

A typical wide-viewing angle technology of the LCD device involves a patterned vertical alignment (“PVA”) mode. In the PVA mode, liquid crystal molecules having a negative anisotropic dielectric constant are vertically aligned and driven perpendicularly in the direction of the electric field, thereby controlling the light transmissivity. Since the light transmission is blocked by a polarizer crossing the alignment direction of the liquid crystal molecules when voltage is not applied, the PVA mode becomes a normally black mode. More specifically, in the PVA mode, a pixel electrode and a common electrode of each sub-pixel are patterned to be divided into multi-domains so that the liquid crystal molecules are aligned symmetrically. Accordingly, the transmissivity variation occurs symmetrically and thereby a wide viewing angle is obtained.

In the case of the PVA mode in which each sub-pixel is divided into two gray levels and driven, the viewing angle is widened when a voltage difference between a high gray level area displaying a data signal at a high gray level and a low gray level area displaying a data signal at a low gray level is large.

### SUMMARY OF THE INVENTION

Exemplary embodiments of the present invention provide a liquid crystal display (“LCD”) that can improve visibility by increasing the difference in root-mean-square (RMS) values between first and second data voltages charged in first and second areas, respectively, and a method of driving the same.

An exemplary embodiment of the present invention provides a liquid crystal display (“LCD”) device including: an LCD panel with a first substrate having first and second pixel electrodes formed in a sub-pixel area, first and second thin film transistors connected to the first and second pixel electrodes, respectively, first and second storage capacitors electrically connected to the first and second pixel electrodes, respectively, first and second gate lines connected to the first and second thin film transistors, respectively, and a data line commonly connected to the first and second transistors, as well as a second substrate facing the first substrate and having a common electrode; and a panel driver including a storage voltage supply unit supplying voltages having phases inverted with respect to each other to the first and second storage capacitors.

The panel driver further includes: a gate driver for supplying gate on/off voltages to the first and second gate lines; a data driver for supplying a data voltage to the data line; and a power unit including a gate driving signal supply unit for generating the gate on/off signals and supplying the same to the gate driver, as well as an analog driving voltage supply unit for supplying an analog driving voltage to the data driver.

The data driver sequentially supplies a first data voltage to the first pixel electrode and a second data voltage to the second pixel electrode, in which one of the first and second data voltages has a level larger than that of the other one.

Moreover, the data driver supplies the first and second data voltages having polarities inverted with respect to each other every frame.

Furthermore, the gate driver supplies the gate-on voltages to the first and second gate lines so as to overlap each other.

In addition, the first substrate includes an organic passivation layer protecting the first and second thin film transistors.

Additionally, the first substrate further includes an inorganic passivation layer formed between the organic passivation layer and the first and second thin film transistors.

Moreover, the first and second pixel electrodes are patterned in the form of a chevron.

Furthermore, the common electrode further includes domain dividing means for dividing the respective areas, in which the first and second pixel electrodes are formed, into a plurality of domains.

In addition, the domain dividing means is formed with at least one of a slit and a projection.

Additionally, the second substrate includes color filters that correspond to the first and second pixel electrodes.

Meanwhile, the organic passivation layer further includes color filters formed along the first and second pixel electrodes.

An exemplary embodiment of the present invention provides a method of driving an LCD device including: sequentially supplying a gate-on voltage to first and second gate lines connected to first and second thin film transistors, respectively; sequentially supplying first and second data voltages to a data line commonly connected to the first and second thin film transistors so as to supply the first and second data voltages to first and second pixel electrodes; supplying a first storage voltage to a first storage capacitor electrically connected to the first pixel electrode so as to shift the first data voltage supplied to the first pixel electrode to a level of the first storage voltage; and supplying a second storage voltage having a phase inverted with respect to the first storage voltage to a second storage capacitor overlapping the second pixel electrode, so as to shift the first data voltage supplied to the second pixel electrode to a level of the second storage voltage.

The step of supplying the first and second data voltages further includes supplying the first and second data voltages having polarities inverted with respect to each other every frame.

The step of supplying the first and second data voltages further includes inverting the first and second storage voltages every time when the first and second data voltages are inverted with respect to each other.

The step of supplying the gate-on voltage to the first and second gate lines further includes supplying the gate-on voltages supplied to the first and second gate lines so as to overlap each other.

In accordance with an exemplary embodiment of the present invention, there is provided a liquid crystal display (LCD) device including: an LCD panel including a first substrate having first and second pixel electrodes, a thin film transistor connected to the first pixel electrode, first and second storage capacitors electrically connected to the first and second pixel electrodes, respectively, a third storage capacitor electrically connected to the first pixel electrode, and a connection electrode electrically connecting the third storage capacitor and the second storage capacitor, and a second substrate facing the first substrate and having a common electrode; and a panel driver including a storage voltage supply unit supplying first and second storage voltages having phases inverted with respect to each other to the first and second storage capacitors.

The first substrate further includes an organic passivation layer protecting the thin film transistor and an inorganic passivation layer formed between the thin film transistor and the organic passivation layer.

The third storage capacitor includes a storage electrode formed to overlap the first pixel electrode along the inorganic passivation layer disposed therebetween in an area where an opening for exposing an inorganic insulating layer penetrating the organic passivation layer is formed.

In this case, the storage electrode is electrically connected to the connection electrode.

Moreover, the thin film transistor further includes a semiconductor layer overlapping the second storage line and formed between the data line and the connection electrode.

Furthermore, the first and second pixel electrodes are formed in the shape of a chevron.

In addition, the common electrode further includes domain dividing means for dividing the respective areas, where the first and second pixel electrodes are formed, into a plurality of domains.

Additionally, the second substrate further includes color filters formed to correspond to the first and second pixel electrodes.

Moreover, the organic passivation layer may be formed with color filters for displaying colors according to the first and second pixel electrodes.

Furthermore, the panel driver includes: a gate driver for driving gate lines; a data driver for driving data lines; a timing controller for supplying control signals to the gate lines and the data lines; and a power unit for generating power signals and supplying the same to the gate driver and the data driver.

In addition, the data driver supplies data voltages having polarities opposite to is each other every frame.

In accordance with an exemplary embodiment of the present invention, there is provided a method of driving an LCD device including: supplying a gate-on voltage to a gate line and a first data voltage to a data line so as to supply the first data voltage to a first pixel electrode connected to a thin film transistor; charging the first data voltage to a third storage capacitor; supplying a second data voltage charged in the third storage capacitor to a second pixel electrode; supplying a first storage voltage to a first storage capacitor electrically connected to the first pixel electrode so as to shift the first data voltage; and supplying a second storage voltage having a phase inverted with respect to the first storage voltage to a second storage capacitor electrically connected to the second pixel electrode so as to shift the second data voltage.

The step of supplying the second data voltage to the second pixel electrode includes: charging the first data voltage supplied to the first pixel electrode in the third storage capacitor; and supplying the second data voltage, having a level between the first data voltage and a voltage charged in a liquid crystal capacitor, formed between the second pixel electrode and a common electrode and connected to the third storage capacitor in series, to the second pixel electrode.

The method of the present invention may further include supplying the data voltages having polarities inverted with respect to each other every frame.

### BRIEF DESCRIPTION OF THE DRAWINGS

Exemplary embodiments of the present invention will be understood in more detail from the following descriptions taken in conjunction with the attached drawings, in which:

FIG. 1 is a plan view of an LCD panel in accordance with exemplary embodiments of the present invention;

FIG. 2 is a cross-sectional view taken along line I-I′ of the LCD panel of FIG. 1 for illustrating an exemplary embodiment of the present invention;

FIGS. 3A and 3B are diagrams comparing areas of pixel electrodes formed in first and second areas of the LCD panel shown in FIG. 1;

FIG. 4 is a cross-sectional view showing a patterned projection formed as a common electrode of a color filter substrate shown in FIG. 2;

FIG. 5 is a cross-sectional view taken along line II-II′ of the LCD panel of FIG. 1 for illustrating an exemplary embodiment of the present invention;

FIG. 6 is a cross-sectional view showing a projection formed as a domain dividing means of a second substrate of FIG. 5;

FIG. 7 is a block diagram schematically illustrating an LCD device including the LCD panel in accordance with exemplary embodiments of the present invention;

FIG. 8 is a block diagram illustrating a power unit shown in FIG. 7;

FIG. 9 is a timing diagram illustrating a method of driving the LCD device including the LCD panel in accordance with exemplary embodiments of the present invention;

FIG. 10 is a graph illustrating a difference in root-mean-square (RMS) values of a first pixel voltage and a second pixel voltage of the LCD device including the LCD panel in accordance with exemplary embodiments of the present invention;

FIG. 11 is a timing diagram illustrating a pre-charge driving method in the LCD device including the LCD panel in accordance with exemplary embodiments of the present invention;

FIG. 12 is a block diagram illustrating a dot-inversion driving method in the LCD device including the LCD panel in accordance with exemplary embodiments of the present invention;

FIG. 13 is a plan view of an LCD panel in accordance with exemplary embodiments of the present invention;

FIG. 14 is a cross-sectional view taken along line III-III′ of the LCD panel of FIG. 13 for illustrating an exemplary embodiment of the present invention;

FIG. 15 is a cross-sectional view taken along line III-III′ of the LCD panel of FIG. 13 for showing a projection formed on a second substrate as a domain dividing means;

FIG. 16 is a plan view of a first substrate of an LCD panel in accordance with an exemplary embodiment of the present invention;

FIG. 17 is a cross-sectional view taken along line V-V′ of the first substrate shown in FIG. 16;

FIG. 18 is a cross-sectional view taken along line IV-IV′ of the LCD panel of FIG. 13 for illustrating an exemplary embodiment of the present invention;

FIG. 19 is a cross-sectional view showing a projection formed as a common electrode of a second substrate of FIG. 18;

FIG. 20 is a block diagram schematically illustrating the LCD device including the LCD panel in accordance with exemplary embodiments of the present invention;

FIG. 21 is a timing diagram illustrating a method of driving the LCD device including the LCD panel in accordance with exemplary embodiments of the present invention; and

FIG. 22 is a graph illustrating a difference in root-mean-square (RMS) values of a first pixel voltage and a second pixel voltage of the LCD device including the LCD panel in accordance with exemplary embodiments of the present invention;

### DETAILED DESCRIPTION OF EXEMPLARY EMBODIMENTS

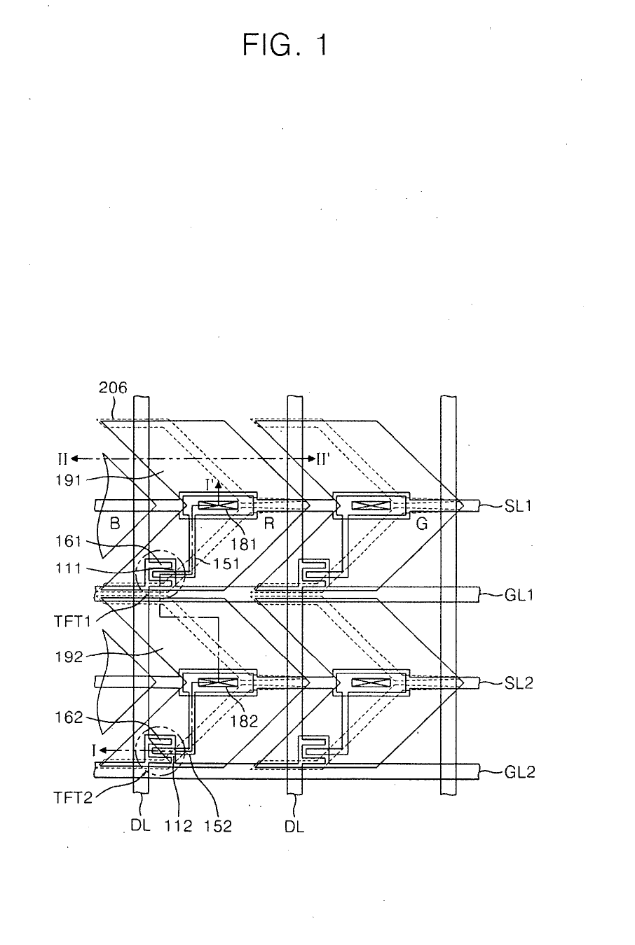

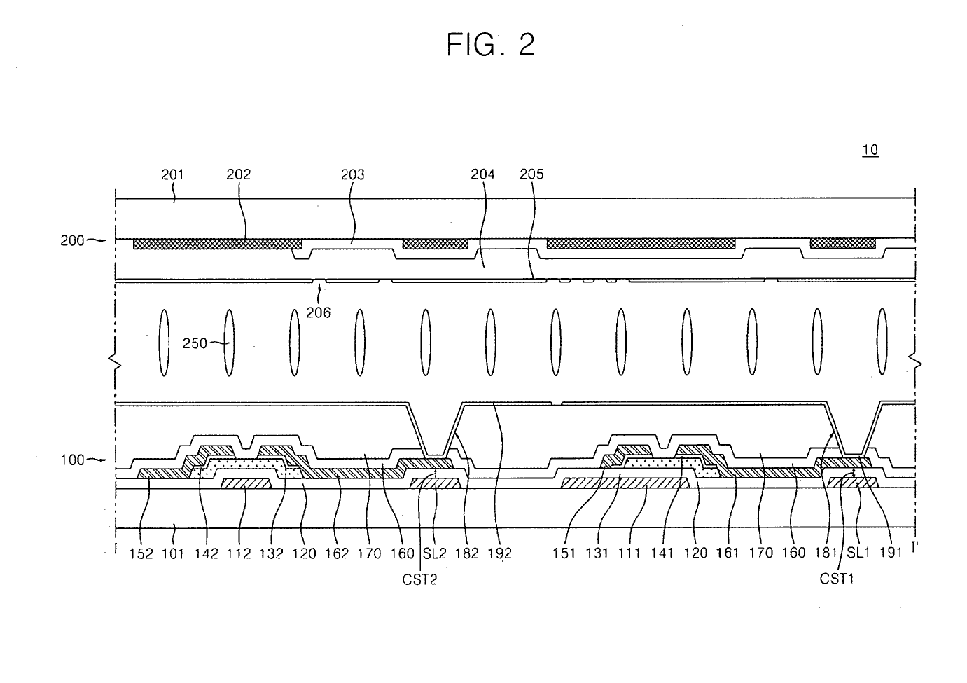

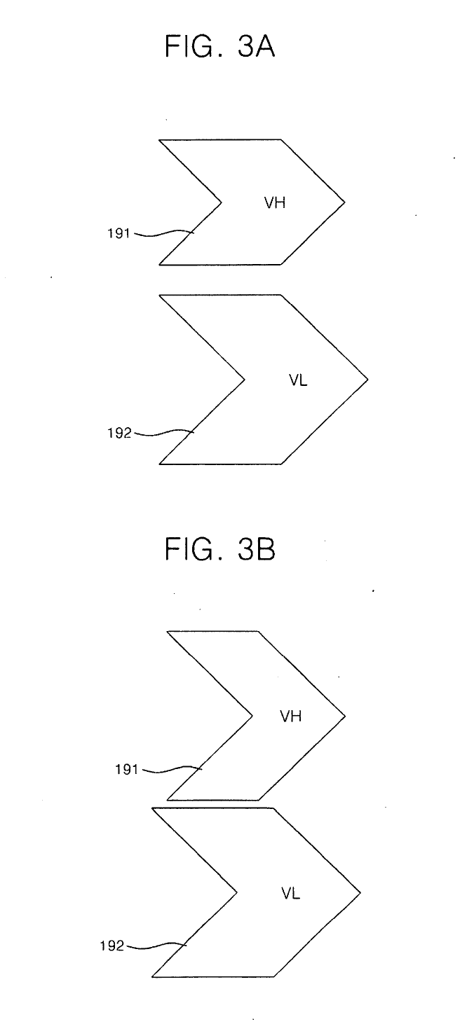

FIG. 1 is a plan view of an LCD panel in accordance with exemplary embodiments of the present invention, FIG. 2 is a cross-sectional view taken along line I-I′ of the LCD panel of FIG. 1 for illustrating an exemplary embodiment of the present invention, and FIGS. 3A and 3B are diagrams comparing areas of pixel electrodes formed in first and second areas of the LCD panel shown in FIG. 1.

Referring to FIGS. 1, 2, 3A, and 3B, the LCD panel 10 in accordance with an exemplary embodiment of the present invention includes a first substrate 100 having a sub-pixel divided into first and second areas, first and second pixel electrodes 191 and 192 formed in the first and second areas, respectively, first and second storage capacitors CST1 and CST2 formed in the first and second areas, respectively, first and second thin film transistors TFT1 and TFT2 connected to the first and second pixel electrodes 191 and 192, respectively, first and second gate lines GL1 and GL2 supplying gate on/off voltages to the first and second thin film transistors TFT1 and TFT2, respectively, and a data line DL commonly connected to the first and second thin film transistors TFT1 and TFT2, and a second substrate 200 facing the first substrate 100 along with a liquid crystal 250 disposed therebetween and including a common electrode 205.

That is, the LCD panel 10 includes the first substrate 100 in which a thin film transistor array (“TFT array”) is formed and the second substrate 200 facing the first substrate 100 along with the liquid crystal 250 disposed therebetween.

The liquid crystal 250 is vertically aligned to be driven by a fringe electric field formed between the first and second substrates 100 and 200. The first and second substrates 100 and 200 sealed together including the liquid crystal 250 disposed therebetween include the first and second areas arranged up and down at each sub-pixel area defined by the intersections between the two gate lines GL1 and GL2 and the one data line DL and displaying gray levels different from each other. In this case, the first area, in which a first liquid crystal capacitor (not shown) formed by the liquid crystal 250 between the first pixel electrode 191 and the common electrode 205 is connected to the first storage capacitor CST1 in parallel, maintains a first charging voltage VH, and the second area, in which a second liquid crystal capacitor (not shown) formed by the liquid crystal 250 between the second pixel electrode 192 and the common electrode 205 is connected to the second storage capacitor CST2 in parallel, maintains a second charging voltage VL, thus displaying an image.

The first area of the first substrate 100 includes the data line DL intersecting the first gate line GL1 formed on a transparent substrate 101, a first thin film transistor TFT1 connected to the first gate line GL1 and the data line DL at the intersection therebetween, a first pixel electrode 191 connected to the first thin film transistor TFT1, and a first storage line SL1 overlapping the first pixel electrode 191 and receiving a first storage voltage. The second area includes the data line DL intersecting the second gate line GL2, a second thin film transistor TFT2 connected to the second gate line GL2 and the data line DL and formed at the intersection of the second gate line GL1 and the data line DL, a second pixel electrode 192 connected to the second thin film transistor TFT2, and a second storage line SL2 overlapping the second pixel electrode 192 and receiving a second storage voltage.

The first and second gate lines GL1 and GL2 are formed in the horizontal direction to the first and second areas to sequentially supply a gate-on voltage to the first and second thin film transistors TFT1 and TFT2.

The data line DL is formed to cross the first and second gate lines GL1 and GL2 to sequentially supply first and second data voltages to the first and second thin film transistors TFT1 and TFT2 every time that the gate-on voltages are applied to the first and second gate lines GL1 and GL2.

The first thin film transistor TFT1 includes the first gate electrode 111 connected to the first gate line GL1, a gate insulating layer 120 formed on the first gate electrode 111, a first semiconductor layer 131 overlapping the first gate electrode 111 and formed on the gate insulating layer 120, a first source electrode 151 overlapping at least the first gate electrode 111 on the first semiconductor layer 131 and connected to the data line DL, and a first drain electrode 161 facing the first source electrode 151 and connected to the first pixel electrode 191 through a first pixel contact hole 181. The first thin film transistor TFT1 is turned on by the gate-on voltage supplied from the first gate line GL1 to supply the first data voltage from the data line DL to the first pixel electrode 191. In this exemplary embodiment, the first drain electrode 161 is formed to overlap the first storage line SL1. That is, the first drain electrode 161 extends to the middle of the first area, and an extending end thereof is formed to have an area equal to or smaller than that of the first storage line SL1 positioned in the middle portion of the first area. Moreover, the first drain electrode 161 is connected to the first pixel electrode 191 through the first pixel contact hole 181 in an area where the first drain electrode 161 and the first storage line SL1 overlap each other.

The second thin film transistor TFT2 is formed in the same manner as the first thin film transistor TFT1. That is, the second thin film transistor TFT2 includes a second gate electrode 112 connected to the second gate line GL2, a gate insulating layer 120 formed on the second gate electrode 112, a second semiconductor layer 132 overlapping the second gate electrode 112 and formed on the gate insulating layer 120, a second source electrode 152 overlapping at least the second gate electrode 112 on the second semiconductor layer 132 and connected to the data line DL, and a second is drain electrode 162 facing the second source electrode 152 and connected to the second pixel electrode 192 through a second pixel contact hole 182. The second thin film transistor TFT2 is turned on by the gate-on voltage supplied from the second gate line GL2 to supply the second data voltage from the data line DL to the second pixel electrode 192. In this exemplary embodiment, the second drain electrode 162 is formed to overlap the second storage line SL2. That is, the second drain electrode 162 extends to the middle of the second area, and an extending end thereof is formed to have an area equal to or smaller than that of the second storage line SL2 positioned in the middle portion of the second area. The second drain electrode 162 is connected to the second pixel electrode 192 through the second pixel contact hole 182 in an area where the second drain electrode 162 and the second storage line SL2 overlap each other.

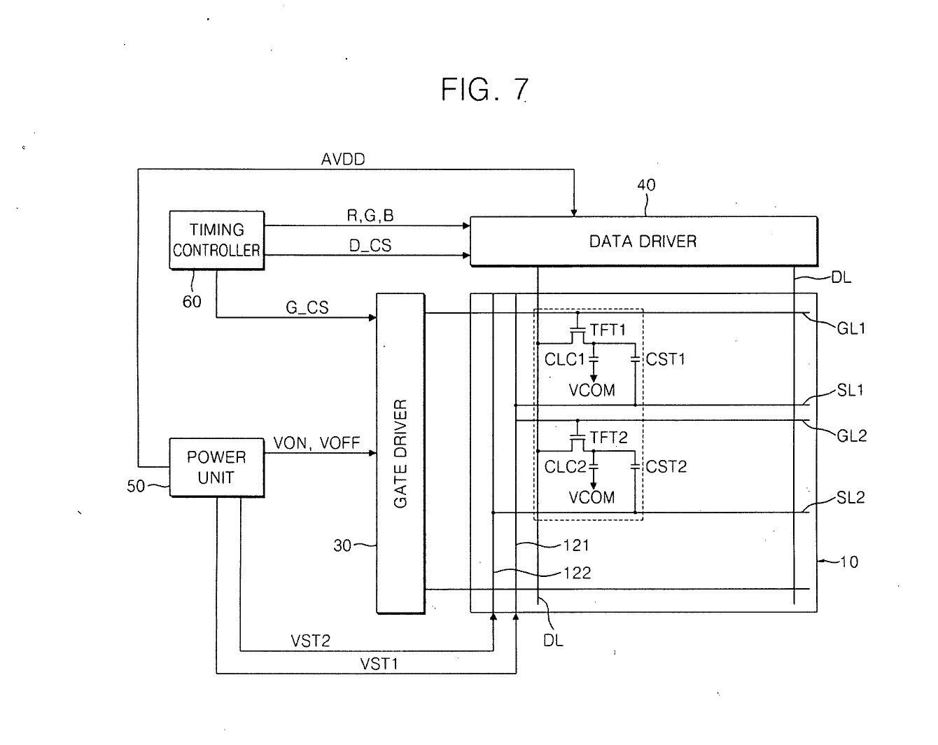

The first storage line SL1 is formed parallel to the first gate line GL1 in the first area and to overlap the middle portion of the first pixel electrode 191. One side of the first storage line SL1 is connected to a first storage voltage supply line, shown at 121 in FIG. 7. At this time, if the one side of the first storage line SL1 is connected to the first storage voltage supply line 121 and the other side thereof is floated, or if the first storage voltage supply line 121 is formed on both sides of the LCD panel 10, the both sides of the first storage line SL1 are connected to the both sides of the first storage voltage supply line 121. The first storage line SL1 overlaps the first drain electrode 161 along the gate insulating layer 120 disposed therebetween to form the first storage capacitor CST1.

The first storage capacitor CST1 shifts the first data voltage to a voltage level supplied to the first storage line SL1 when the first data voltage is charged in the first pixel electrode 191. A detailed description of this operation will be given later.

The second storage line SL2 is formed parallel to the second gate line GL2 so as to overlap the middle portion of the second pixel electrode 192 formed in the second area. One side of the second storage line SL2 is connected to a second storage voltage supply line, shown at 122 in FIG. 7. At this time, if the one side of the second storage line SL2 is connected to the second storage voltage supply line 122 and the other side thereof is floated, or if the second storage voltage supply line 122 is formed on both sides of the LCD panel 10, both sides of the second storage line SL2 are connected to both sides of the second storage voltage supply line 122. The second storage line SL2 overlaps the second drain electrode 162 along the gate insulating layer 120 disposed therebetween to form a second storage capacitor CST2.

The second storage capacitor CST2 shifts the second data voltage to a voltage level supplied to the second storage line SL2 when the second data voltage VD2 is charged in the second pixel electrode 192.

The first pixel electrode 191 is formed in the first area in the shape of a chevron having left and right lateral sides arranged in a zigzag structure. In this case, the first pixel electrode 191 is formed symmetrically with respect to a horizontal line connecting two points where the lateral sides of the first pixel electrode 191 meet each other. Moreover, the lateral sides of the first pixel electrode 191 are formed to be inclined at an angle of 45° with respect to polarizing plates formed on upper and lower surfaces of the LCD panel 10, respectively. Accordingly, the transmissivity of light transmitted through the polarizing plates from a backlight is maximized.

The second pixel electrode 192 is formed in the second area in the same shape as the first pixel electrode 191.

One of the first and second pixel electrodes 191 and 192 may be formed to have an area smaller than that of the other one. In this exemplary embodiment, the one pixel electrode formed in one of the first and second areas that is supplied with a low voltage is formed to have an area larger than that of the other pixel electrode formed in the other area that is supplied with a high voltage. As shown in FIGS. 3A and 3B, the first area is supplied with the first data voltage and the second area is supplied with the second data voltage. At this time, the first data voltage is supplied with a high gray level voltage VH and the second data voltage is supplied with a low gray level voltage VL. Accordingly, the second pixel electrode 192 may be formed to have an area larger than that of the first pixel electrode 191 in order to improve visibility. More specifically, as shown FIG. 3A, the widths of the first and second pixel electrodes 191 and 192 are the same as each other, whereas the height of the second pixel electrode 192 is set larger than that of the first pixel electrode 191. On the other hand, as shown in FIG. 3B, the width of the second pixel electrode is formed larger than that of the first pixel electrode 191 to make the area of the second pixel electrode 191 larger than that of the first pixel electrode 191.

An organic passivation layer 170 is formed beneath the first and second pixel electrodes 191 and 192 as shown in FIG. 2. The organic passivation layer 170 is formed with a thickness of about 2 to 3 μm to prevent signal interference that may be caused when the first and second pixel electrodes 191 and 192 are formed to overlap the first and second gate lines GL1 and GL2 and the data line DL. Accordingly, the first and second pixel electrodes 191 and 192 can be formed to overlap the first and second gate lines GL1 and GL2 and the data line DL, thereby increasing the aperture ratio of the LCD panel 10. In this case, an inorganic passivation layer 160 may be further formed beneath the organic passivation layer 170 to improve the off-current characteristics of the first and second thin film transistors TFT1 and TFT2. The first and second pixel contact holes 181 and 182 connecting the first and second drain electrodes 161 and 162 with the first and second pixel electrodes 191 and 192, respectively, are formed to penetrate the organic and inorganic passivation layers 170 and 160.

The second substrate 200 includes a black matrix 202 formed to face the first substrate 100, a color filter 203, an overcoat layer 204, and a common electrode 205.

The black matrix 202 is formed on a transparent substrate 201 to prevent light leakage generated from the first thin film transistor TFT1 and the gate lines GL1 and GL2 of the first substrate 100.

The color filter 203, including red (R), green (G) and blue (B) color resins, is formed corresponding to the first and second pixel electrodes 191 and 192 of the first substrate 100. The overcoat layer 204 may be further provided between the color filter 203 and the common electrode 205. The overcoat layer 204 formed between the color filter 203 and the common electrode 205 compensates for height differences caused by adjacent sub-pixels formed to overlap one another on the black matrix 202, thereby planarizing the common electrode 205.

The common electrode 205 is formed on the color filter 203 and the black matrix 202 and generates a fringe field together with the first and second pixel electrodes 191 and 192. In this case, the common electrode 205 includes domain dividing means for dividing the first and second areas into a plurality of domains, that is, a slit 206 formed to alternate with the lateral and upper sides of the first and second pixel electrodes 191 and 192, as shown in FIG. 2. More specifically, the slit 206 having a ‘Y’ shape is formed to be inclined at 90 degrees with respect to the horizontal direction corresponding to the first and second pixel electrodes 191 and 192, as shown in FIG. 1. Accordingly, the respective first and second areas are divided into a plurality of domains by the lateral sides of the first and second pixel electrodes 191 and 192 and the slit 206 of the common electrode 205, thereby widening the viewing angle.

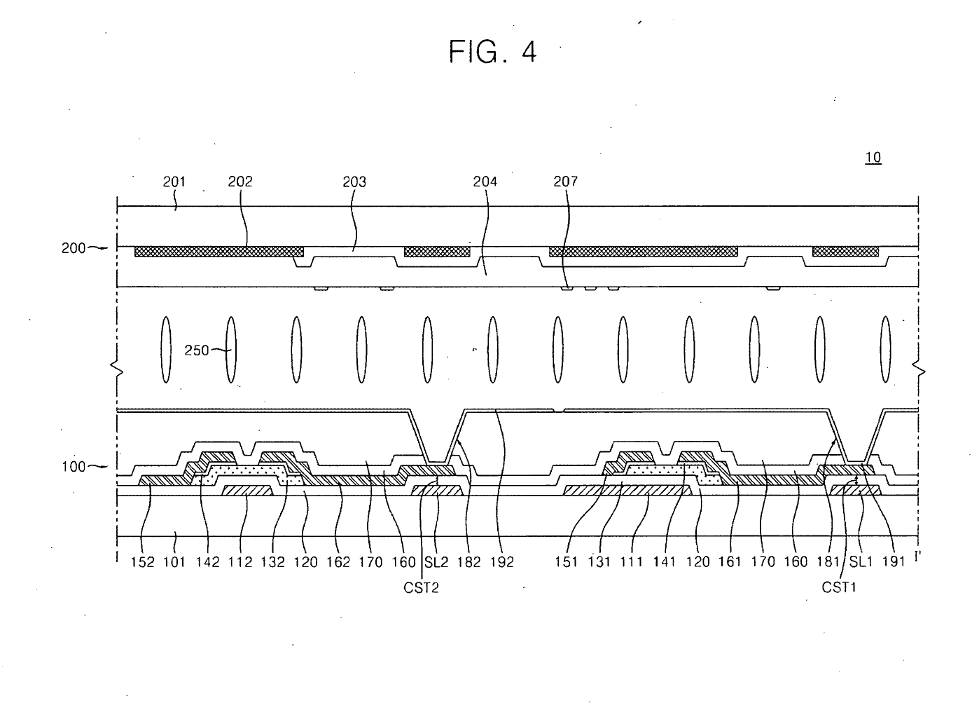

As shown in FIG. 4, the domain dividing means may include a projection 207. The projection 207 is formed in the same pattern as the slit 206. That is, the projection 207 having a ‘Y’ shape is formed to be inclined at 90 degrees with respect to the horizontal direction corresponding to the patterned first and second pixel electrodes 191 and 192 and, at the same time, formed to alternate with the patterned first and second pixel electrodes 191 and 192.

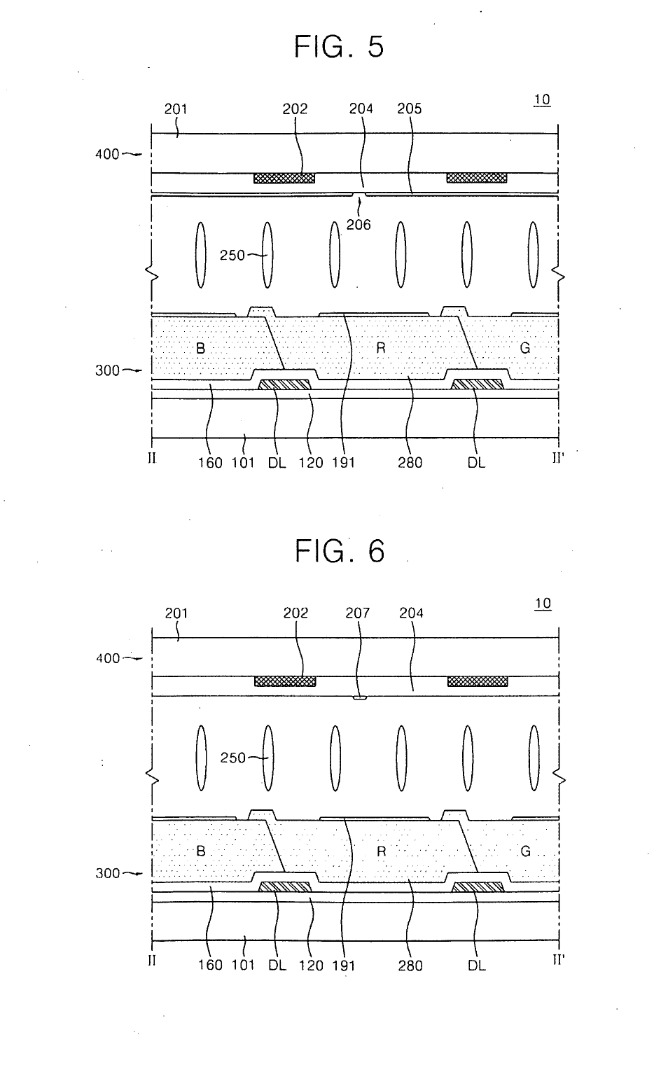

FIG. 5 is a cross-sectional view taken along line II-II′ of the LCD panel of FIG. 1 for illustrating an exemplary embodiment of the present invention. The LCD panel according to an exemplary embodiment of the present invention includes a first substrate 300 and a second substrate 400. The first substrate 300 is a color filter-on-thin film transistor substrate (“COA substrate”) including color filters 280 formed on a transparent substrate 101. Since the LCD panel includes the same elements as FIG. 2, except for the color filters 280 used instead of the organic passivation layer 170, a repeated description will be omitted. Moreover, the LCD panel includes the same elements as FIG. 2, except for the elimination of the color filters 203 on the second substrate 200 of FIG. 2.

When employed in the structure shown in FIG. 1, the first substrate 300 shown in FIG. 5 includes a sub-pixel having first and second areas formed on the transparent substrate 101, first and second pixel electrodes 191 and 192 formed on the first and second areas, respectively, first and second thin film transistors TFT1 and TFT2 supplying data voltages having different gray levels to the first and second pixel electrodes 191 and 192, respectively, a first gate line GL1 supplying gate on/off voltages to the first thin film transistor TFT1, a second gate line GL2 supplying gate on/off voltages to the second thin film transistor TFT2, a data line DL formed to cross the first and second gate lines GL1 and GL2 and connected to the first and second thin film transistors TFT1 and TFT2, a first storage line SL1 overlapping the first pixel electrode 191 to form a first storage capacitor CST1, shown in FIG. 2, in the first area, and a second storage line SL2 overlapping the second pixel electrode 192 to form a second storage capacitor CST2, shown in FIG. 2, in the second area. The first substrate 300 further includes an inorganic passivation layer 160 protecting the first and second thin film transistors TFT1 and TFT2 and the data line DL, and color filters 280 of red (R), green (G) and blue (B) formed in each sub-pixel area between the inorganic passivation layer 160 and the first and second pixel electrodes 191 and 192.

The first and second pixel electrodes 191 and 192 are formed in the shape of a chevron. One pixel electrode formed in one of the first and second areas supplied with a low voltage may be formed to have an area larger than that of the other pixel electrode formed in the other area supplied with a high voltage to improve visibility, as described in relation to FIGS. 3A and 3B.

The color filters 280 are formed of an organic material to overlap each other beneath the first and second pixel electrodes 191 and 192. In this case, a first pixel contact hole, shown at 181 in FIG. 2, penetrating the color filter 280 and the inorganic passivation layer 160 is formed to connect the first drain electrode 161 of the first thin film transistor TFT1 and the first pixel electrode 191. A second pixel contact hole, shown at 182 in FIG. 2, penetrating the color filter 280 and the inorganic passivation layer 160 is formed to connect the second drain electrode 162 of the second thin film transistor TFT2 and the second pixel electrode 192.

The first substrate 300 as described above can simplify the manufacturing process by forming the color filters 280 on the first substrate 300.

The second substrate 400 includes a black matrix 202 and a common electrode 205 formed on a transparent substrate 201. The overcoat layer 204 planarizing the common electrode 205 may be further provided between the black matrix 202 and the common electrode 205. The common electrode 205 includes a slit 206 with a ‘Y’ shape formed to be inclined at 90 degrees with respect to the horizontal direction corresponding to the first and second pixel electrodes 191 and 192 of the first substrate 100, as shown in FIG. 1. The slit 206 is formed alternating with the patterned first and second pixel electrodes 191 and 192 to divide the sub-pixel into a plurality of domains. That is, since a fringe field is formed between the lateral sides of the first and second pixel electrodes 191 and 192 and the slit 206 of the common electrode 205, the respective first and second areas are divided into a plurality of domains and thereby the viewing angle is widened.

As shown in FIG. 6, the domain dividing means may include a projection 207. The projection 207 is formed in the same pattern as the slit 206 shown in FIG. 5. That is, the projection 207 having a ‘Y’ shape is formed to be inclined at 90 degrees with respect to the horizontal direction corresponding to the patterned first and second pixel electrodes 191 and 192 and, at the same time, formed to alternate with the patterned first and second pixel electrodes 191 and 192.

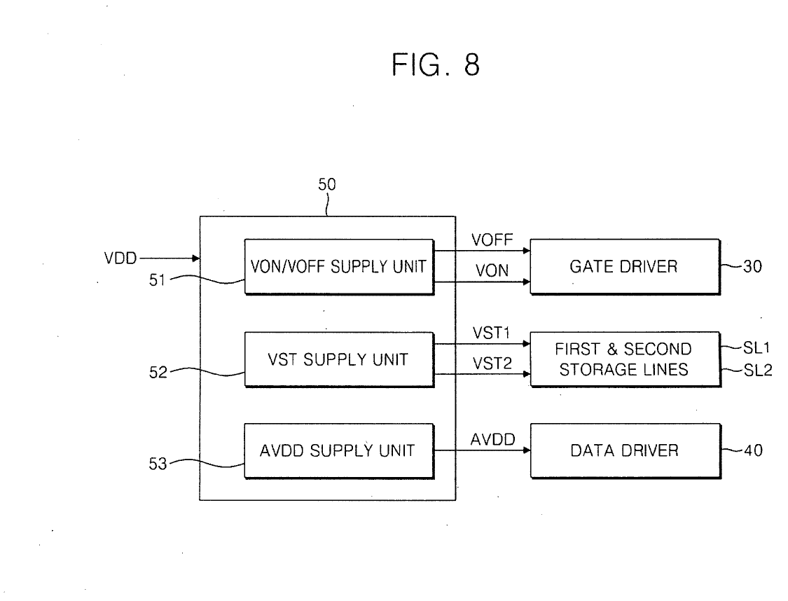

FIG. 7 is a block diagram schematically illustrating an LCD device including the LCD panel in accordance with the exemplary embodiments of the present invention described above, and FIG. 8 is a block diagram illustrating the power unit shown in FIG. 7.

Referring to FIGS. 7 and 8, the LCD device including the LCD panel in accordance with the above-described exemplary embodiments of the present invention includes an LCD panel 10 and a panel driver for driving the LCD panel 10. The panel driver includes a gate driver 30 for driving gate lines GL1 and GL2, a data driver 40 for driving data lines DL, a timing controller 60 supplying control signals to the gate driver 30 and the data driver 40 and applying a pixel data signal to the data driver 40, and a power unit 50 supplying power signals to the data driver 40 and the LCD panel 10.

More specifically, as shown in FIG. 8, the power unit 50 includes a gate on/off voltage supply unit 51 generating gate on/off voltages VON and VOFF and supplying the same to the gate driver 30, an analog driving voltage supply unit 53 generating an analog driving voltage AVDD and supplying the same to the data driver 40, and a storage voltage supply unit 52 generating first and second storage voltages VST1 and VST2 and supplying the same to first and second storage lines SL1 and SL2 of the LCD panel 10. The gate on/off voltage supply unit 51 generates a gate-on voltage VON of about 20 to 25V and a gate-off voltage VOFF of about −7 to 0V and supplies the same to the gate driver 30. The analog driving supply unit 53 supplies a DC voltage of about 11 to 18V to a gamma voltage generator (not shown) included in the data driver 40 to be used as a reference voltage of the gamma voltage generator. The storage voltage supply unit 52 supplies the first and second storage voltages VST1 and VST2 to the first and second storage lines SL1 and SL2, respectively. The first and second storage voltages VST1 and VST2 that are supplied have phases that are inverted with respect to each other. The power unit 50 may further include a common voltage supply unit (not shown) generating a common voltage VCOM and supplying the same to the LCD panel 10. The common voltage supply unit generates a DC voltage VCOM of 0 to 5V and applies the same to the common electrode 205 of the second substrates 200 and 400.

The timing controller 60 receives image data signals of R, G and B from the outside and supplies the same to the data driver 40. The timing controller 60 generates a plurality of control signals for controlling driving timings of the data driver 40 and the gate driver 30 using a plurality of synchronization signals, such as a dot clock, a data enable signal, a vertical synchronization signal, a horizontal synchronization signal, and the like, input together with the image data signals from the outside, and supplies the same to the data driver 40 and the gate driver 30. For example, the timing controller 60 generates gate control signals G_CS including a gate start pulse, a gate shift clock, an output control signal, and the like and supplies the same to the gate driver 30. The time controller 60 also generates data control signals D_CS including a data start pulse, a data shift clock, a polarity control signal, and the like and supplies the same to the data driver 40.

The gate driver 30 sequentially supplies the gate-on voltage VON to the first gate line GL1 for driving the first thin film transistor TFT1 of the first area and to the second gate line GL2 for driving the second thin film transistor TFT2 of the second area.

The gate driver 30 sequentially transmits the gate-on voltage VON supplied from the power unit 50 according to the gate control signal G_CS applied from the timing controller 60 and supplies the gate-off voltage VOFF for the remainder of the time. At this time, the gate driver 30 supplies the gate-on voltages VON to the first and second gate lines GL1 and GL2 so as to overlap each other. Accordingly, the gate driver 30 turns on the second thin film transistor TFT2 before the first thin film transistor TFT1 is turned off and thereby pre-charges the second pixel electrode 192 formed in the second area.

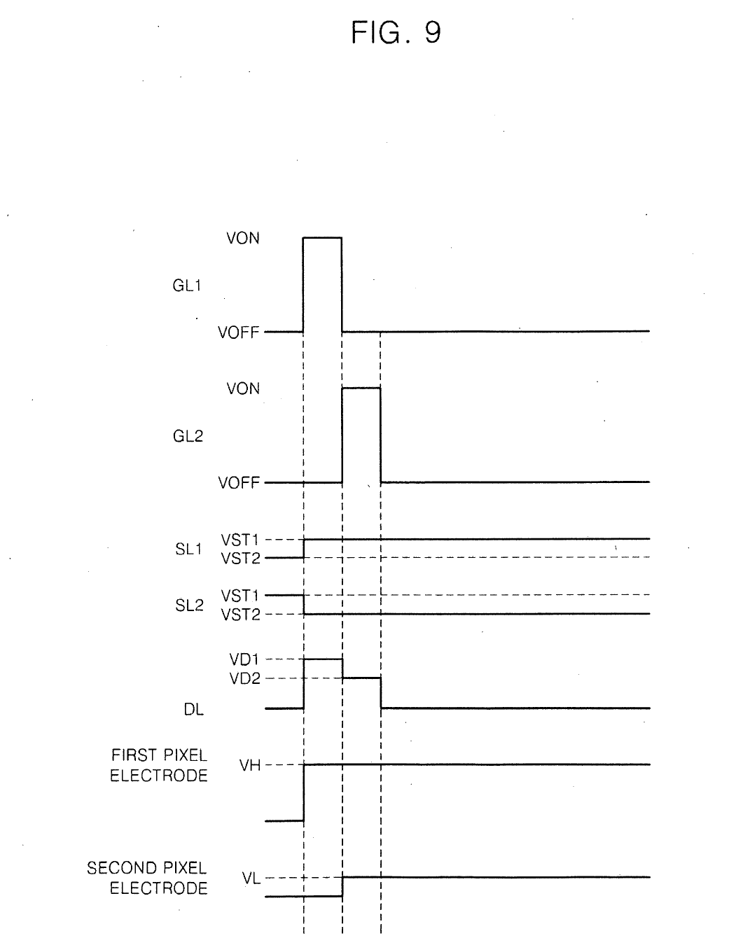

The data driver 40 converts a digital data signal into an analog data signal in response to the data control signal D_CS from the timing controller 60 and sequentially supplies the first and second data voltages VD1 and VD2 converted into the analog is signals to the data lines DL every time that the gate-on voltage VON is sequentially supplied to the first and second gate lines GL1 and GL2. Although not shown, the data driver 40 includes a shift register, a latch unit, a digital-analog converter, an output buffer, and a gamma voltage supply unit. The shift register sequentially shifts the data start pulse from the timing controller 60 according to the data shift clock and, at the same time, generates a sampling signal. The latch unit sequentially latches the data signals of R, G and B input from the timing controller 60 in response to the sampling signal and, if the data corresponding to one horizontal line is all latched, supplies the same to the digital-analog converter at the same time. The digital-analog converter selects a gamma voltage, corresponding to the data from the latch unit, from the gamma voltages supplied from the gamma voltage supply unit and outputs the same as an analog data voltage. The output buffer buffers the data signal from the digital-analog converter and supplies the same to the data line DL. At this time, the gamma voltage supply unit may further include a high gray level voltage supply unit generating a high gray level voltage and a low gray level voltage supply unit generating a low gray level voltage. For example, after the high gray level voltage generated from the high gray level voltage supply unit is output in any frame, the low gray level voltage generated from the low gray level gamma voltage supply unit in the next frame is supplied to the digital-analog converter. That is, after the first data voltage VD1, shown in FIG. 9, is output from any one of the high and low gray level voltage supply units, the second data voltage VD2, shown in FIG. 9, at a lower level than the first data voltage VD1 is sequentially output.

Meanwhile, the digital-analog converter selects a positive or negative polarity gamma voltage according to the polarity control signal from the timing controller 60 and outputs the same as the analog data voltage. The digital-analog converter outputs data signals having polarities opposite to each other to adjacent output channels in response to the polarity control signal corresponding to a known vertical dot inversion method, so that the polarities of the data voltages supplied through the output channels may be inverted in a horizontal period unit.

Next, a method of driving the LCD device including the LCD panel in accordance with the above-described exemplary embodiments of the present invention will be described with reference to FIGS. 9 to 12.

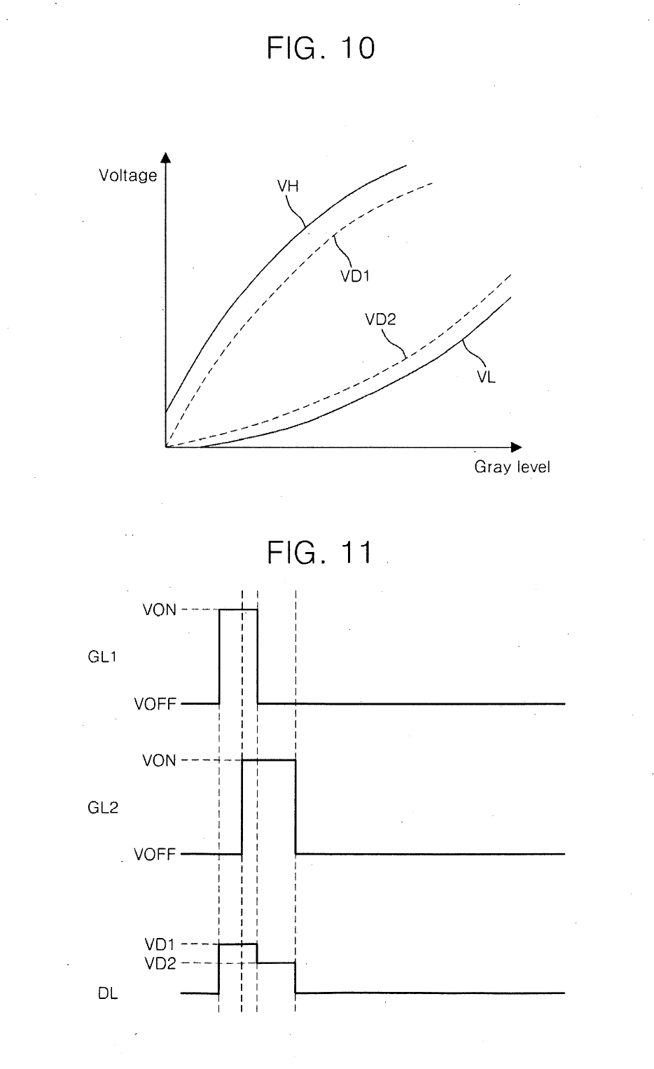

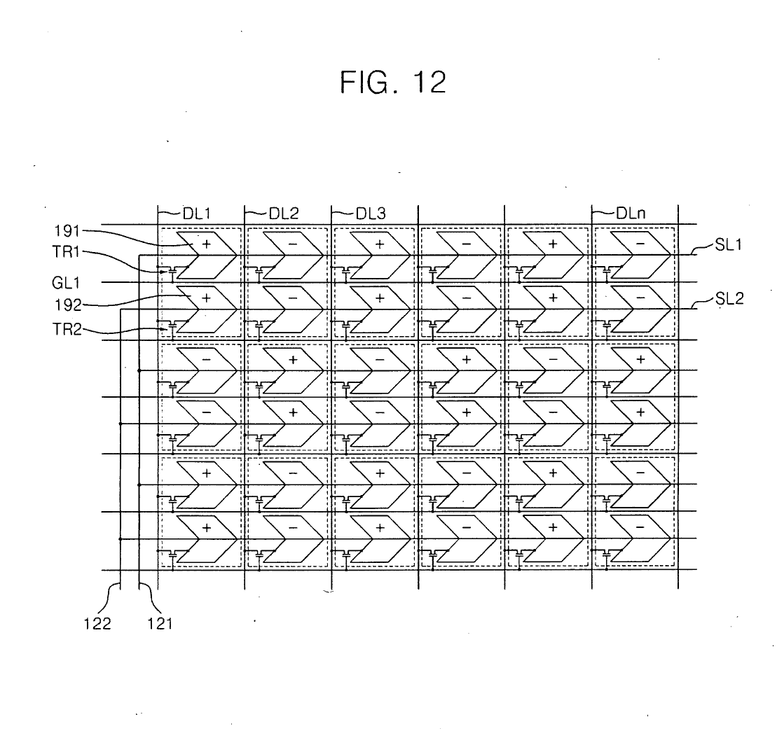

FIG. 9 is a timing diagram illustrating the method of driving the LCD device including the LCD panel in accordance with the above-described exemplary embodiments of the present invention, FIG. 10 is a graph illustrating first and second data voltages supplied according to respective gray levels and first and second pixel voltages charged in the first and second pixel electrodes, FIG. 11 is a timing diagram illustrating a pre-charge driving method, and FIG. 12 is a block diagram illustrating a dot-inversion driving method.

Referring to FIGS. 9 to 12, if the gate-on voltage VON is supplied to the first gate line GL1, the first thin film transistor, shown at TFT1 in FIG. 1, is turned on and thereby the first data voltage VD1 supplied from the data line DL is transmitted to the first pixel electrode 191. At this time, the first storage voltage VST1 is supplied to the first storage line SL1 to shift the first data voltage VD1 supplied to the first pixel electrode 191 to a level of the first storage voltage VST1. In this case, the first data voltage VD1 that is supplied is a high voltage and, accordingly, the first storage voltage VST1 that is supplied to the first storage line SL1 to shift the first data voltage VD1 is a high voltage. Subsequently, if the gate-on voltage VON is supplied to the second gate line GL2, the second thin film transistor, shown at TFT2 in FIG. 1, is turned on, whereby the second data voltage VD2 supplied from the data line DL is transmitted to the second pixel electrode 192. At this time, the second storage voltage VST2 is supplied to the second is storage line SL2 to shift the second data voltage VD2 that is supplied to the second pixel electrode 192 to a level of the second storage voltage VST2. In this case, the second data voltage VD2 supplied is a low voltage compared with the first data voltage VD1 and the second storage voltage VST2 having a phase different from the first storage voltage VST1 is supplied to the second storage line SL2, thereby shifting the level of the second data voltage VD2 in a direction that the second storage voltage VST2 swings. Accordingly, as shown in FIG. 9, since the first and second data voltages VD1 and VD2 supplied from the data line DL are shifted to the levels of the first and second storage voltages VST1 and VST2, the difference between the first and second pixel voltages VH and VL charged in the first and second pixel electrodes 191 and 192 is increased. In this exemplary embodiment, it is desirable that the difference between the first and second storage voltages VST1 and VST2 be within 2 to 5V.

The relationship between root-mean-square (“RMS”) values of the first and second pixel voltages VH and VL and the storage voltage VST1 and VST2 is represented by the following formula 1:

$$\vert V H [ RMS ] = \frac{\sqrt{\begin{matrix}{( VD 1 - VCOM )}^{2} + ( \vert VD 1 - VCOM \vert \pm \vert VD 1 - \\ {VCOM \vert Δ VCST 1 \times \frac{CST 1}{CST 1 + CLC 1} )}^{2}\end{matrix}}}{2} \vert \\ V L [ RMS ] = \sqrt{\frac{\begin{matrix}{( VD 2 - VCOM )}^{2} + ( \vert VD 2 - VCOM \vert ∓ \vert VD 2 - \\ {VCOM \vert Δ VCST 2 \times \frac{CST 2}{CST 2 + CLC 2} )}^{2}\end{matrix}}{2}} \qquad [ Formula 1 ]$$

wherein VH[RMS] represents a first pixel voltage VH of a high gray level charged in the first pixel electrode 191 and VL[RMS] represents a second pixel voltage VL of a low gray level charged in the second pixel electrode 192.

Since the RMS values of the VH and the VL represent the first and second pixel voltages VH and VL actually charged in the first and second pixel electrodes 191 and 192, respectively, the visibility is improved significantly by the difference value between the first and second storage voltages VST1 and VST2 supplied to the first and second storage lines SL1 and SL2, respectively. Accordingly, since the first and second storage voltages VST1 and VST2 have a difference of 2 to 5V, the visibility is improved by this difference value.

The gate-on voltage VON supplied through the second gate line GL2 may 20 overlap the gate-on voltage VON supplied to the first gate line GL1. As shown in FIG. 11, the second thin film transistor TFT2 is turned on, before the second data voltage VD2 is input, to pre-charge a portion of the first data voltage VD1 to the second pixel electrode 192 and then, if the second data voltage VD2 is input, the second data voltage VD2 is charged to the second pixel electrode 192, thereby driving the liquid crystal 250 at a higher speed.

FIG. 12 is a block diagram illustrating the LCD device including the LCD panel in accordance with the above-described exemplary embodiments of the present invention driven by a dot-inversion driving method.

Referring to FIG. 12, the first and second pixel electrodes 191 and 192 formed in each sub-pixel are inverted in a horizontal period unit, that is, every frame.

More specifically, the data driver 40 selects a positive or negative polarity gamma voltage according to the polarity control signal from the timing controller 60 and outputs the same as an analog data voltage. When the inverted first and second data voltages VD1 and VD2 are supplied, the first and second storage voltages VST1 and VST2 are also inverted and supplied.

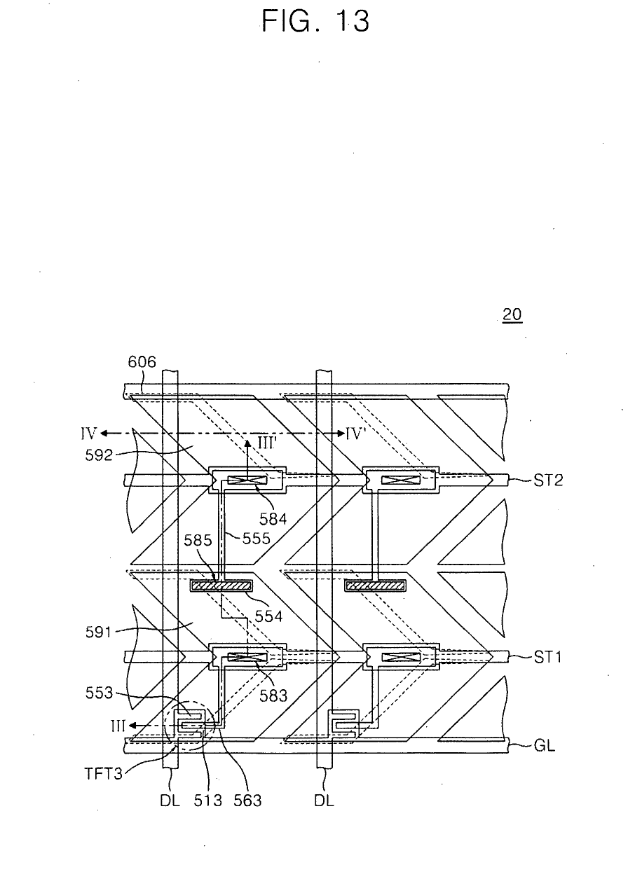

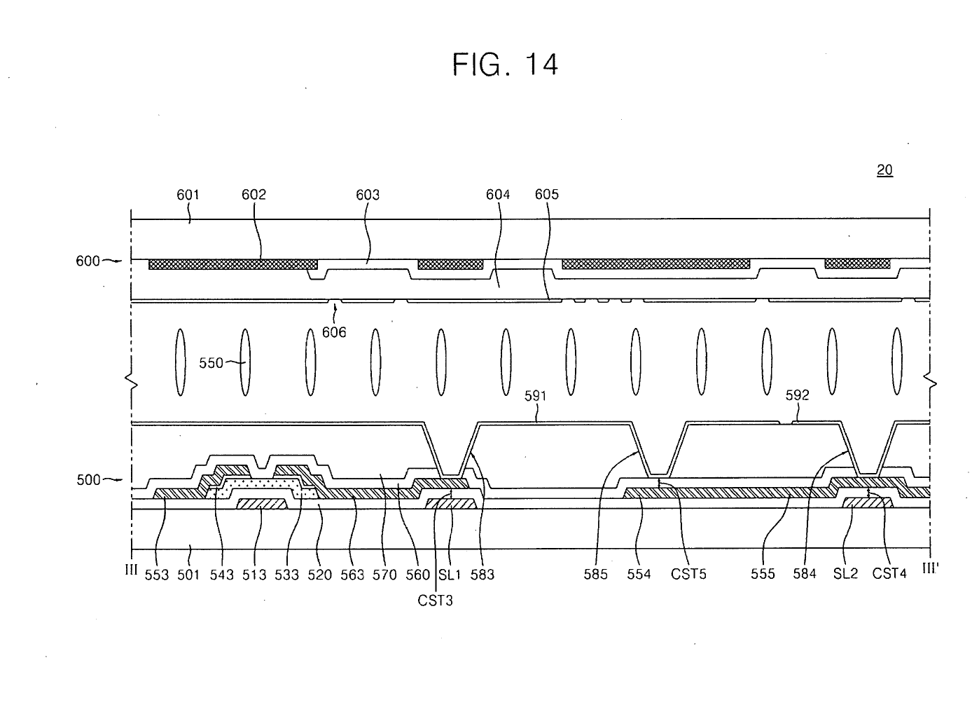

FIG. 13 is a plan view of an LCD panel in accordance with exemplary embodiments of the present invention, and FIG. 14 is a cross-sectional view taken along line III-III′ of the LCD panel of FIG. 13 for illustrating an exemplary embodiment of the present invention.

Referring to FIGS. 13 and 14, the LCD panel in accordance with an exemplary embodiment of the present invention includes a first substrate 500 on which a TFT array is formed, a second substrate 600 facing the first substrate 500 and including a color filter array, and a liquid crystal 550 vertically aligned between the first and second substrates 500 and 600. The first substrate 500 includes a sub-pixel formed by the intersection between a gate line GL and a data line DL, first and second areas formed at each sub-pixel and displaying high and low gray levels, first and second pixel electrodes 591 and 592 formed in the first and second areas, respectively, first and second storage lines SL1 and SL2 overlapping the first and second pixel electrodes 591 and 592 to form third and fourth storage capacitors CST3 and CST4, a storage electrode 554 overlapping the first pixel electrode 591, and a connection electrode 555 supplying a second data voltage VD2 charged in the storage electrode 554 to the second pixel electrode 592.

The liquid crystal 550 is vertically aligned and driven by a fringe electric field formed between the first and second substrates 500 and 600.

The first and second substrates 500 and 600 sealed together including the liquid crystal 550 disposed therebetween include the first and second areas provided up and down at each sub-pixel area defined by the intersections between two gate lines GL1 and GL2 and one data line DL and displaying gray levels different from each other. The first area, in which a first liquid crystal capacitor (not shown) formed by the liquid crystal 550 between the first pixel electrode 591 and a common electrode 605 is connected to the third storage capacitor CST3 in parallel, maintains a first charging is voltage VH, and the second area, in which a second liquid crystal capacitor (not shown) formed by the liquid crystal 550 between the second pixel electrode 592 and the common electrode 605 is connected to a fifth storage capacitor CST5, connected to the first area, in series and connected to a fourth storage capacitor CST4 in parallel, maintains a second charging voltage VL, thereby displaying an image.

The first area of the first substrate 500 includes the data line DL formed to intersect the gate line GL, a third thin film transistor TFT3 connected to the gate line GL and the data line DL at the intersection therebetween, the first pixel electrode 591 connected to the third thin film transistor TFT3, and the storage electrode 554 overlapping the first pixel electrode 591 and supplying the second data voltage VD2 to the second pixel electrode 592. The second area includes the second pixel electrode 592, the second storage line SL2 overlapping the second pixel electrode 592 and receiving the second storage voltage VST2, and the connection electrode 555 formed to overlap the second pixel electrode 592 along an inorganic passivation layer 560, the connection electrode 555 electrically connecting the storage electrode 554 and the second pixel electrode 592.

The gate line GL is formed in the horizontal direction along the first area on the transparent substrate 501 to supply the gate-on voltage VON to the third thin film transistor TFT3.

The data line DL is formed to cross the gate line GL to supply the first data voltage VD1 to the third thin film transistor TFT3 every time that the gate-on voltage VON is applied to the gate line GL.

The third thin film transistor TFT3 includes a third gate electrode 513 connected to the gate line GL, a gate insulating layer 520 formed on the third gate electrode 513, a third semiconductor layer 533 overlapping the third gate electrode 513 and formed on is the gate insulating layer 520, a third source electrode 553 formed to overlap at least the third gate electrode 513 on the third semiconductor layer 533 and connected to the data line DL, and a third drain electrode 563 facing the third source electrode 553 and connected to the first pixel electrode 591 through a third pixel contact hole 583. The third thin film transistor TFT3 is turned on by the gate-on voltage VON supplied from the gate line GL to supply the first data voltage VD1 from the data line DL to the first pixel electrode 591. In this exemplary embodiment, the third drain electrode 563 is formed to overlap the first storage line SL1. More specifically, the third drain electrode 563 extends to the middle of the first area, and an extending end thereof is formed to have an area equal to or smaller than that of the first storage line SL1 positioned in the middle portion of the first area. The first drain electrode 563 is connected to the first pixel electrode 591 through the third pixel contact hole 583 in an area where the third drain electrode 563 and the first storage line SL1 overlap each other.

The first storage line SL1 is formed parallel to the gate line GL in the first area, so as to overlap the middle portion of the first pixel electrode 591. One side of the first storage line SL1 is connected to a first storage voltage supply line 121. At this time, if the one side of the first storage line SL1 is connected to the first storage voltage supply line 121 and the other side thereof is floated, or if the first storage voltage supply line 121 is formed on both sides of the LCD panel 20, both sides of the first storage line SL1 are connected to both sides of the first storage voltage supply line 121. The first storage line SL1 overlaps the third drain electrode 563 along the gate insulating layer 520 disposed therebetween to form a third storage capacitor CST3.

The third storage capacitor CST3 shifts the first data voltage VD1 to a voltage level that is supplied to the first storage line SL1 when the first data voltage VD1 is charged in the first pixel electrode 591.

The second storage line SL2 is formed parallel to the gate line GL, so as to overlap the middle portion of the second pixel electrode 592 formed in the second area. One side of the second storage line SL2 is connected to a second storage voltage supply line 122. If the one side of the second storage line SL2 is connected to the second storage voltage supply line 122 and the other side thereof is floated, or if the second storage voltage supply line 122 is formed on both sides of the LCD panel 20, both sides of the second storage line SL2 are connected to both sides of the second storage voltage supply line 122. The second storage line SL2 overlaps the second pixel electrode 592 along the gate insulating layer 520 disposed therebetween to form a fourth storage capacitor CST4. The fourth storage capacitor CST4 shifts the second data voltage VD2 to a voltage level that is supplied to the second storage line SL2 when the second data voltage VD2 is supplied from the fifth storage capacitor CST5 to the second pixel electrode 592.

The storage electrode 554 is formed to overlap the first pixel electrode 591 along the inorganic passivation layer 560 disposed therebetween to form the fifth storage capacitor CST5. The storage electrode 554 charges the first data voltage VD1 that is supplied to the first pixel electrode 591 and supplies the same to the second pixel electrode 592. More specifically, the first data voltage VD1 charged to the fifth storage capacitor CST5 is supplied to the second pixel electrode 592 through the connection electrode 555. Because the fifth storage capacitor CST5 is connected to the second liquid crystal capacitor (not shown) in series, the second data voltage VD2 that is supplied to the second pixel electrode 592 is the voltage between the first pixel electrode 591 and the second liquid crystal capacitor. In other words, the second data voltage VD2 supplied is a low voltage compared with the first data voltage VD1.

The first pixel electrode 591 is formed in the first area in the shape of a chevron having left and right lateral sides arranged in a zigzag structure. The first pixel electrode 591 is formed symmetrically with respect to a horizontal line connecting two points where the lateral sides of the first pixel electrode 591 meet each other. Furthermore, the lateral sides of the first pixel electrode 591 are formed to be inclined at an angle of 45° with respect to polarizing plates formed on upper and lower surfaces of the LCD panel 20, respectively. Accordingly, the transmissivity of light transmitted by the polarizing plates from a backlight is maximized.

The second pixel electrode 592 is formed in the second area in the same shape as the first pixel electrode 591.

The sides of the connection electrode 555 are electrically connected to the storage electrode 554 and the second pixel electrode 592, respectively. The connection electrode 555 is formed to have a wide area so as to overlap the second storage line SL2 in an area connected to the second pixel electrode 592.

One of the first and second pixel electrodes 591 and 592 may be formed to have an area smaller than that of the other one.

An organic passivation layer 570 is formed beneath the first and second pixel electrodes 591 and 592, as shown in FIG. 14. The organic passivation layer 570 is formed with a thickness of about 2 to 3 μm to prevent signal interference even if the first and second pixel electrodes 591 and 592 are formed to overlap the gate line GL and the data line DL. Accordingly, the first and second pixel electrodes 591 and 592 can be formed to overlap the gate line GL and the data line DL, thereby increasing the aperture ratio of the LCD panel 20. A further inorganic passivation layer 560 may be formed beneath the organic passivation layer 570 to improve the off-current characteristics of the third thin film transistor TFT3. The third pixel contact hole 583 connecting the third drain electrode 563 with the first pixel electrode 591 is formed to penetrate the organic is and inorganic passivation layers 570 and 560. The fourth pixel contact hole 584 connecting the connection electrode 555 with the second pixel electrode 592 is also formed to penetrate the organic and inorganic passivation layers 570 and 560. An opening 585 eliminating the organic passivation layer 570 is formed in an area where the storage electrode 554 and the first pixel electrode 591 overlap each other, so as to increase the capacity of the fifth storage capacitor CST5. Accordingly, the storage electrode 554 and the first pixel electrode 591 overlap each other along the inorganic passivation layer 560 disposed therebetween.

The second substrate 600 includes a black matrix 602, a color filter 603, and a common electrode 605 on a transparent substrate 601.

The black matrix 602 is formed to prevent light leakage generated from the third thin film transistor TFT3 and the gate line GL of the first substrate 500.

The color filter 603 including red (R), green (G) and blue (B) color resins formed corresponding to the first and second pixel electrodes 591 and 592 of the first substrate 500. In this exemplary embodiment, an overcoat layer 604 may be further provided between the color filter 603 and the common electrode 605. The overcoat layer 604 formed between the color filter 603 and the common electrode 605 compensates height differences caused by adjacent sub-pixels formed to overlap one another on the black matrix 602, thereby planarizing the common electrode 605.

The common electrode 605 is formed on the color filter 603 and the black matrix 602 and generates a fringe electric field together with the first and second pixel electrodes 591 and 592. In this case, the common electrode 605 includes domain dividing means for dividing the respective first and second areas into a plurality of domains. As the domain dividing means, a slit 606 having a ‘Y’ shape is formed to be inclined at 90 degrees with respect to the horizontal direction corresponding to the first and second pixel electrodes 591 and 592. The slit 606 is formed alternating with the patterns of the first and second pixel electrodes 591 and 592 to divide the sub-pixel into a plurality of domains. That is, a fringe electric field is formed between the lateral sides of the first and second pixel electrodes 591 and 592 and the slit 606 of the common electrode 605 so that the respective first and second areas are divided into a plurality of domains, thereby widening the viewing angle.

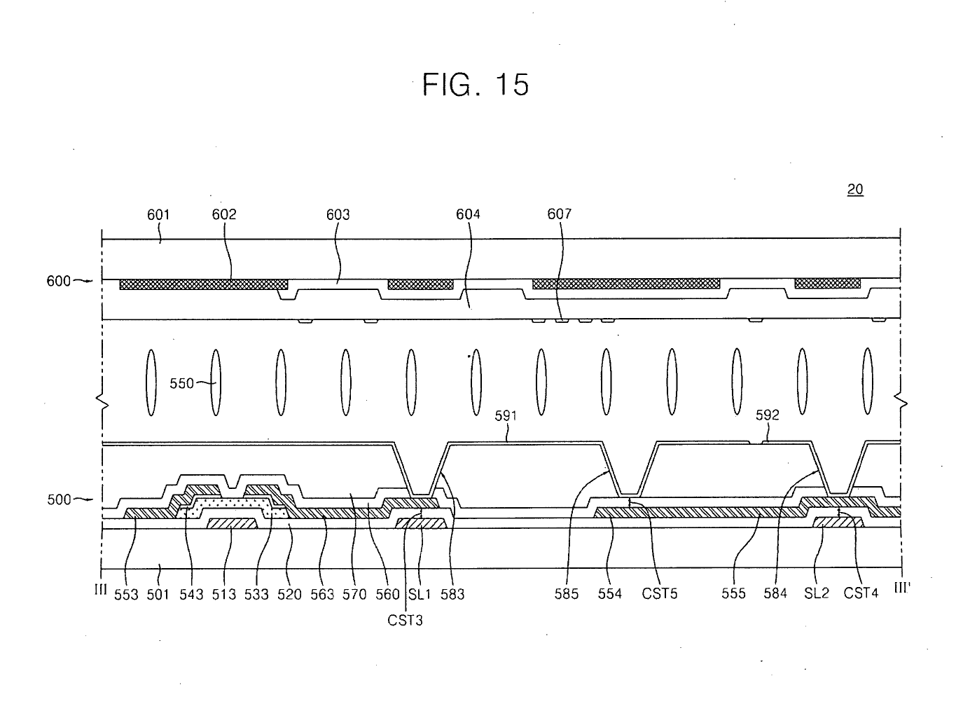

As shown in FIG. 15, the domain dividing means may include a projection 607. The projection 607 is formed in the same pattern as the slit 606. More specifically, the projection 607 having a ‘Y’ shape is formed to be inclined at 90 degrees with respect to the horizontal direction corresponding to the patterned first and second pixel electrodes 591 and 592 and, at the same time, formed to alternate with the patterned first and second pixel electrodes 591 and 592.

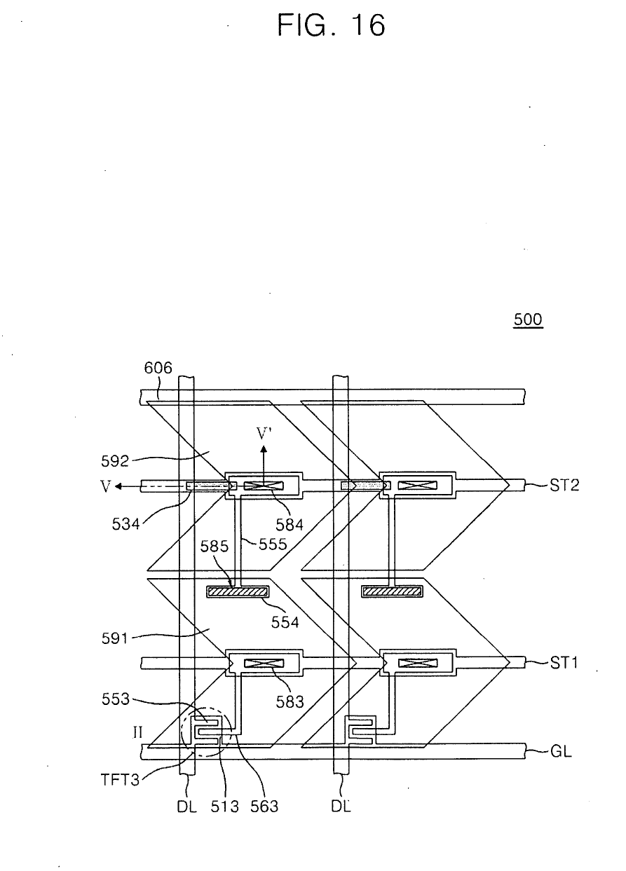

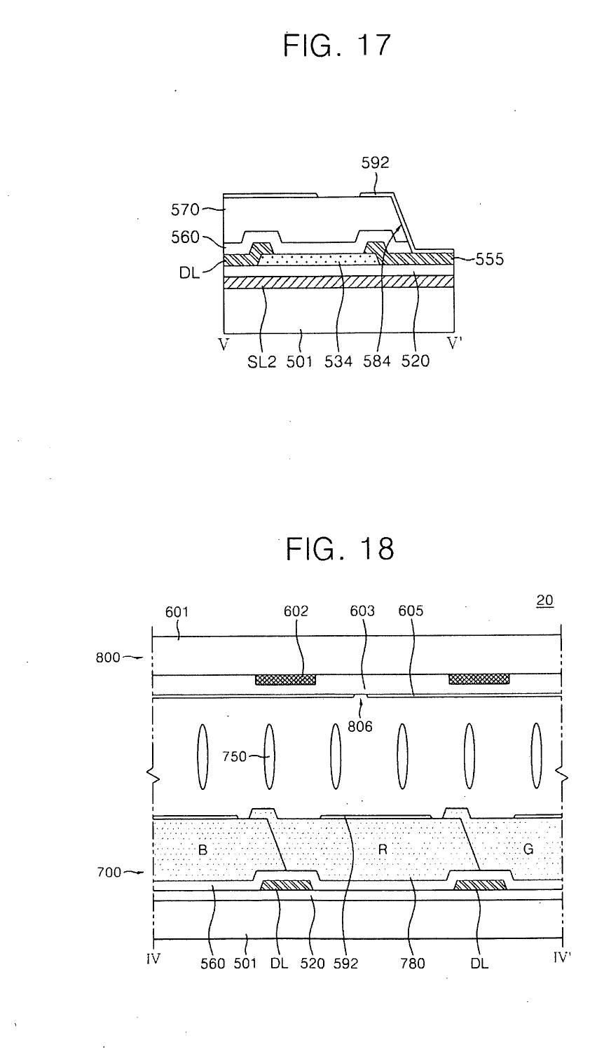

FIG. 16 is a plan view of a first substrate of an LCD panel 500 in accordance with an exemplary embodiment of the present invention, and FIG. 17 is a cross-sectional view taken along line V-V′ of the first substrate of FIG. 16.

Because the LCD panel of FIGS. 16 and 17 includes the same elements as that shown in FIGS. 13 and 14, except for a fourth semiconductor layer 534 formed to discharge a residual voltage charged in the second pixel electrode of the second area, a repeated description will be omitted.

More specifically, the fourth semiconductor layer 534 is formed on the gate insulating layer 520 to overlap the second storage line SL2. One side of the fourth semiconductor layer 534 is formed to overlap a portion of the data line DL and the other side thereof is formed to overlap the connection electrode 555. Accordingly, the fourth semiconductor layer 534 functions as a channel when the voltage of the data line DL is discharged from the connection electrode 555. More specifically, after the second pixel electrode 592 is charged during one frame period, the second charging voltage VL charged in the second pixel electrode 592 should be all discharged before the second data voltage VD2 is charged in the next frame. All of the second charging voltage VL, however, may not be discharged due to parasitic capacitors formed in the second pixel electrode 592. Accordingly, if a voltage is not supplied to the data line DL, but is applied to the second storage line SL2 before the second data voltage VD2 is input, the residual voltage of the second pixel electrode 592 is discharged to the data line DL through the fourth semiconductor layer 534 functioning as a channel. Accordingly, the residual voltage is all discharged from the second pixel electrode 592, thereby improving the image quality.

FIG. 18 is a cross-sectional view taken along line IV-IV′ of the LCD panel 20 of FIG. 13 for illustrating an exemplary embodiment of the present invention. The LCD panel 20 according to this exemplary embodiment of the present invention includes a first substrate 700 and a second substrate 800. The first substrate 700 is a COA substrate including a color filter 780 formed on a transparent substrate 501. Because the LCD panel includes the same elements as shown in FIG. 17, except for the color filter 780 formed instead of the organic passivation layer 570, a repeated description will be omitted. The LCD panel includes the same elements as shown in FIG. 17, except for the elimination of the color filter 603 on the second substrate 600 of FIG. 17.

The first substrate 700 includes a sub-pixel having first and second areas formed on the transparent substrate 501, first and second pixel electrodes 591 and 592 formed on the first and second areas, respectively, a third thin film transistor, shown at TFT3 in FIG. 16, supplying a first data voltage VD1 to the first pixel electrode 591, a gate line GL supplying gate on/off voltages to the third thin film transistor TFT3, a data line DL intersecting the gate line GL and connected to the third thin film transistor TFT3, a first storage line SL1 overlapping the first pixel electrode 591 to form a third storage capacitor, shown at CST3 in FIG. 15, in the first area, and a second storage line SL2 overlapping the second pixel electrode 592 to form a fourth storage capacitor, shown at CST4 in FIG. 15, in the second area. The first substrate 700 further includes a storage electrode 554 shown in FIG. 16 overlapping the first pixel electrode 591 to form a fifth storage capacitor, shown at CST5 in FIG. 15, and a connection electrode 555 connecting the storage electrode 554 and the second pixel electrode 592 to supply a second data voltage VD2 from the fifth storage capacitor CST5 to the second pixel electrode 592. In this exemplary embodiment one end of the connection electrode 555 is formed to overlap the second storage line SL2.

The first substrate 700 further includes an inorganic passivation layer 560 protecting the third thin film transistor TFT3 and the data line DL, and color filters 780 of red (R), green (G) and blue (B) formed in each sub-pixel area between the inorganic passivation layer 560 and the first and second pixel electrodes 591 and 592.

The first and second pixel electrodes 591 and 592 are formed in the shape of a chevron in the same manner as that of FIG. 13 for illustrating the above-described exemplary embodiment of the present invention. The color filter 780 is formed of an organic material at each sub-pixel area. A third pixel contact hole 583 shown in FIG. 15 penetrating the color filter 780 and the inorganic passivation layer 560 is formed to connect a third drain electrode 563 of the third thin film transistor TFT3 and the first pixel electrode 591. An opening 585 eliminating the color filter 780 in an area where the first pixel electrode 591 and the storage electrode 554 overlap each other is formed so as to increase the capacity of the fifth storage capacitor CST5.

The first 700 substrate as described above can simplify the manufacturing process by forming the color filters 780 on the first substrate 700 including a thin film transistor array.

The second substrate 800 includes a black matrix 602 and a common electrode 605 formed on a transparent substrate 801. The overcoat layer 604 may be further provided between the black matrix 602 and the common electrode 605. As shown in FIG. 18, the common electrode 605 includes a slit 806 formed alternating with the lateral sides of the first and second pixel electrodes 591 and 592 to divide the sub-pixel into a plurality of domains. More specifically, because a fringe electric field is formed between the lateral sides of the first and second pixel electrodes 591 and 592 and the slit 806 of the common electrode 605, the respective first and second areas are divided into a plurality of domains and thereby the viewing angle is widened.

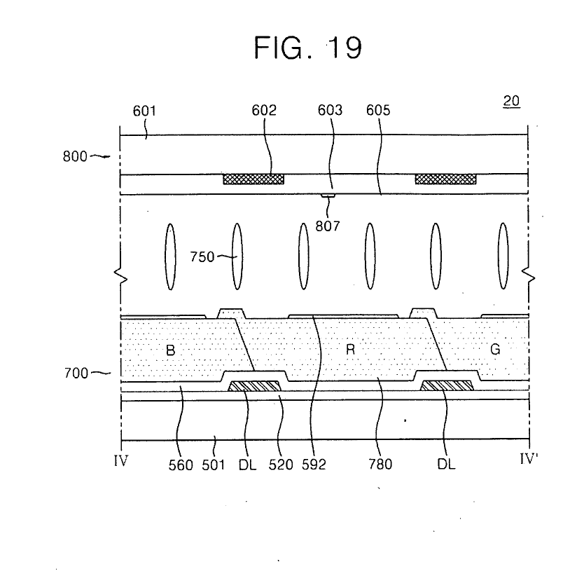

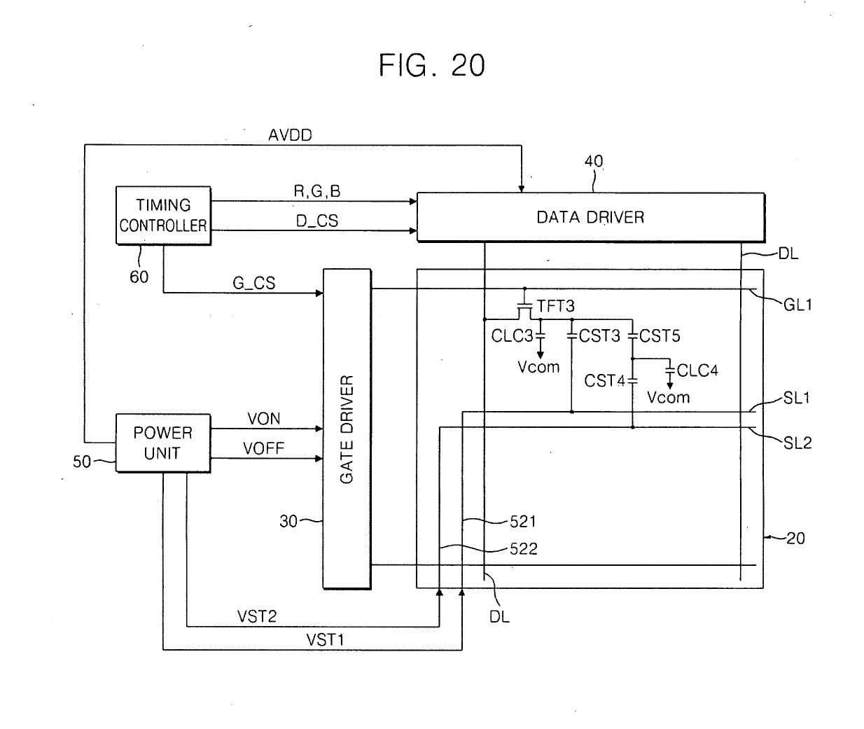

As shown in FIG. 19, the domain dividing means may include a projection 807. The projection 807 is formed in the same pattern as the slit 806. That is, the projection 807 having a ‘Y’ shape is formed to be inclined at 90 degrees with respect to the horizontal direction corresponding to the patterned first and second pixel electrodes 591 and 592 and, at the same time, formed to alternate with the patterned first and second pixel electrodes 591 and 592.

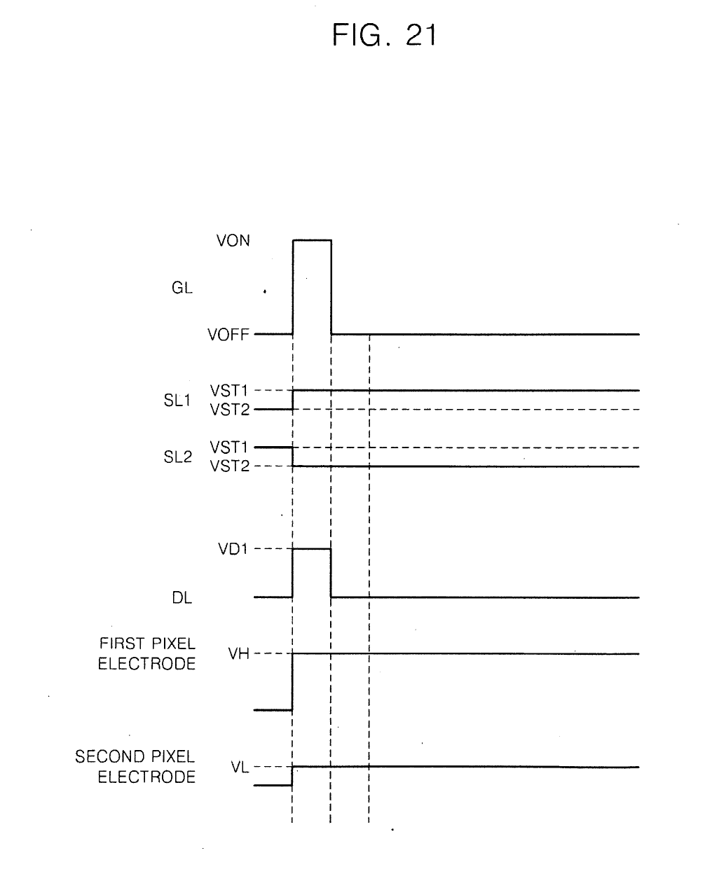

FIG. 20 is a block diagram schematically illustrating the LCD device including the LCD panel in accordance with the above-described exemplary embodiments of the present invention.

As shown in FIG. 20, the LCD device including the LCD panel in accordance with the above-described exemplary embodiments of the present invention includes an LCD panel 20, a gate driver 30 for driving gate lines GL of the LCD panel 20, a data driver 40 for driving data lines DL of the LCD panel 20, a timing controller 60 supplying control signals to the gate driver 30 and the data driver 40 and applying a pixel data is signal to the data driver 40, and a power unit 50 supplying power signals to the data driver 40 and the LCD panel 20.

In more detail, the power unit 50 includes a gate on/off voltage supply unit (not shown) generating gate on/off voltages VON and VOFF and supplying the same to the gate driver 30, an analog driving voltage supply unit (not shown) generating an analog driving voltage AVDD and supplying the same to the data driver 40, a common voltage supply unit generating a common voltage VCOM and supplying the same to the common electrode, shown at 605 in FIG. 14, of the LCD panel 20, and a storage voltage supply unit generating first and second storage voltages VST1 and VST2 and supplying the same to first and second storage lines SL1 and SL2 of the LCD panel 20. The storage voltage supply unit supplies the first and second storage voltages VST1 and VST2 to the first and second storage lines SL1 and SL2. The first and second storage voltages VST1 and VST2 that are supplied have their phases inverted with respect to each other.

The timing controller 60 receives image data signals of R, G and B from the outside and supplies the same to the data driver 40. The timing controller 60 generates a plurality of control signals for controlling driving timings of the data driver 40 and the gate driver 30 using a plurality of synchronization signals, such as a dot clock, a data enable signal, a vertical synchronization signal, a horizontal synchronization signal, and the like, input together with the image data signals from the outside, and supplies the same to the data driver 40 and the gate driver 30. For example, the timing controller 60 generates gate control signals G_CS including a gate start pulse, a gate shift clock, an output control signal, and the like and supplies the same to the gate driver 30. The timing controller 60 generates data control signals D_CS including a data start pulse, a data shift clock, a polarity control signal, and the like and supplies the same to the data driver 40.

The gate driver 30 supplies the gate-on voltage VON for driving the third thin film transistor TFT3 of the first area. The gate driver 30 sequentially transmits the gate-on voltage VON supplied from the power unit 50 according to the gate control signal G_CS applied from the timing controller 60 and supplies the gate-off voltage VOFF for the remainder of the time.

The data driver 40 converts a digital data signal into an analog data signal in response to the data control signal D_CS from the timing controller 60 and sequentially supplies the first data voltage VD1 converted into the analog signal to the data lines DL every time that the gate-on voltage VON is supplied to the gate lines GL. Although not shown, the data driver 40 includes a shift register, a latch unit, a digital-analog converter, an output buffer, and a gamma voltage supply unit. The shift register sequentially shifts the data start pulse from the timing controller 60 according to the data shift clock and, at the same time, generates a sampling signal. The latch unit sequentially latches the data signals of R, G and B input from the timing controller 60 in response to the sampling signal and, if the data corresponding to one horizontal line is latched, supplies the same to the digital-analog converter at the same time. The digital-analog converter selects a gamma voltage, corresponding to the data from the latch unit, from the gamma voltages supplied form the gamma voltage supply unit and outputs the same as an analog data voltage. The output buffer buffers the data signal from the digital-analog converter and supplies the same to the data line DL.

The digital-analog converter selects a positive or negative polarity gamma voltage according the polarity control signal from the timing controller 60 and outputs the same as the analog data voltage. More specifically, the digital-analog converter outputs data signals having polarities opposite to each other to adjacent output is channels in response to the polarity control signal corresponding to a vertical dot inversion method so that the polarities of the data voltages supplied through the output channels may be inverted in a horizontal period unit.

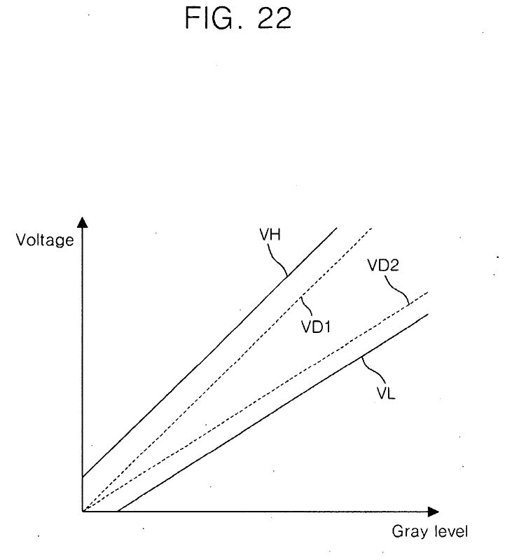

Next, a method of driving the LCD device including the LCD panel in accordance with the above-described exemplary embodiments of the present invention will be described with reference to FIGS. 21 and 22.

FIG. 21 is a timing diagram illustrating a method of driving the LCD device including the LCD panel in accordance with the above-described exemplary embodiments of the present invention, and FIG. 22 is a graph illustrating a data voltage supplied at a high gray level and first and second pixel voltages charged in the first and second pixel electrodes.

Referring to FIGS. 21 and 22, if the gate-on voltage VON is supplied to the gate line GL, the third thin film transistor TFT3 is turned on and thereby the first data voltage VD1 supplied from the data line DL is transmitted to the first pixel electrode 591. At this time, the first storage voltage VST1 is supplied to the first storage line SL1 to shift the first data voltage VD1 supplied to the first pixel electrode 591 to a level of the first storage voltage VST1. In this case, the first data voltage VD1 that is supplied is a high voltage and accordingly the first storage voltage VST1 supplied to the first storage line SL1 to shift the first data voltage VD1 is a high voltage. Subsequently, the second data voltage VD2 is supplied to the second pixel electrode 592 of the fifth storage capacitor CST5. At this time, the second storage voltage VST2 is supplied to the second storage line SL2 to shift the second data voltage VD2 supplied to the second pixel electrode 592 to a level of the second storage voltage VST2. In this case, the second data voltage VD2 that is supplied to the second pixel electrode 592 is a voltage having a level lower than that of the first data voltage VD1 supplied to the first pixel electrode 591, is that is, an intermediate level between the first data voltage VD1 and the voltage charged in the second liquid crystal capacitor CLC2. The second storage voltage VST2 having a phase different from the first storage voltage VST1 is supplied to the second storage line SL2, thereby shifting the level of the voltage supplied to the second pixel electrode 592 in a direction that the second storage voltage VST2 swings. Accordingly, as shown in the graph of FIG. 22, because the first data voltage VD1 supplied from the data line DL to the first pixel electrode 591 is shifted to the level of the first storage voltage VST1 and the first data voltage VD1 supplied to the second pixel electrode 592 through the fifth storage capacitor CST5 is shifted to the level of the second storage voltage VST2, the difference between the first and second pixel voltages VH and VL charged in the first and second pixel electrodes 591 and 592 is increased. In this exemplary embodiment, it is desirable that the difference value between the first and second storage voltages VST1 and VST2 be within 2 to 5V. Accordingly, the difference in the RMS values of the first and second pixel voltages VH and VL charged in the first and second pixel electrodes 591 and 592 is increased to improve the visibility.

In this case, the first and second pixel electrodes 591 and 592 formed at each sub-pixel are inverted in a horizontal period unit, that is, every frame. In other words, the first data voltage VD1 is inverted on the basis of the common voltage in the horizontal period unit and supplied. To this end, the data driver 40 selects a positive or negative polarity gamma voltage according the polarity control signal from the timing controller 60 and outputs the same as the analog data voltage. At this time, it is desirable that the first and second storage voltages VST1 and VST2 are inverted and supplied when the first data voltage VD1 is inverted and supplied.

As described above, the LCD device and the method of driving the same in accordance with exemplary embodiments of the present invention can improve the visibility by supplying the storage voltages having phases inverted with respect to each other to the first and second areas to increase the difference in the RMS values of the first and second pixel voltages, in which each of the first and second areas includes the first and second pixel electrodes, the first and second thin film transistors for driving the first and second pixel electrodes, respectively, and the first and second gate lines for supplying the gate-on voltages to the first and second thin film transistors, respectively.

The LCD device and the method of driving the same in accordance with exemplary embodiments of the present invention can improve the visibility by reducing the data voltage of the first area and supplying the same to the second area and by supplying the storage voltages having phases inverted with respect to each other to the first and second areas to increase the difference in the RMS values of the first and second pixel voltages.

Furthermore, exemplary embodiments of the present invention can reduce the manufacturing time and cost by forming the color filters with an organic insulating material on the first substrate including the thin film transistor array.

In addition, exemplary embodiments of the present invention can increase the aperture ratio using the organic passivation layer.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A liquid crystal display (LCD) device comprising:
an LCD panel including a first substrate having first and second pixel electrodes formed in a sub-pixel area, first and second thin film transistors connected to the first and second pixel electrodes, respectively, first and second storage capacitors electrically connected to the first and second pixel electrodes, respectively, first and second gate lines connected to the first and second thin film transistors, respectively, and a data line commonly connected to the first and second transistors, and a second substrate facing the first substrate and having a common electrode; and
a panel driver including a storage voltage supply unit supplying voltages having phases inverted with respect to each other to the first and second storage capacitors.

2. The LCD device of claim 1, wherein the first substrate comprises an organic passivation layer protecting the first and second thin film transistors.

3. The LCD device of claim 2, wherein the first substrate further comprises an inorganic passivation layer formed between the organic passivation layer and the first and second thin film transistors.

4. The LCD device of claim 3, wherein the common electrode further comprises domain dividing means for dividing respective areas, in which the first and second pixel electrodes are formed, into a plurality of domains.

5. The LCD device of claim 4, wherein the second substrate comprises color filters formed corresponding to the first and second pixel electrodes.

6. The LCD device of claim 2, wherein the organic passivation layer further comprises color filters formed along the first and second pixel electrodes.

7. A method of driving a liquid crystal display (LCD) device, comprising:
sequentially supplying a gate-on voltage to first and second gate lines connected to first and second thin film transistors, respectively;
sequentially supplying first and second data voltages to a data line commonly connected to the first and second thin film transistors so as to supply the first and second data voltages to first and second pixel electrodes;
supplying a first storage voltage to a first storage capacitor electrically connected to the first pixel electrode so as to shift the first data voltage supplied to the first pixel electrode to a level of the first storage voltage; and
supplying a second storage voltage having a phase inverted with respect to the first storage voltage to a second storage capacitor overlapping the second pixel electrode so as to shift the first data voltage supplied to the second pixel electrode to a level of the second storage voltage.

8. The method of claim 7, wherein supplying the first and second data voltages comprises inverting the first and second storage voltages every time when the first and second data voltages are inverted with respect to each other.

9. The method of claim 7, wherein supplying the gate-on voltage to the first and second gate lines comprises supplying the gate-on voltages to the first and second gate lines so as to overlap each other.

10. A liquid crystal display (LCD) device comprising:
an LCD panel including a first substrate having first and second pixel electrodes, a thin film transistor connected to the first pixel electrode, first and second storage capacitors electrically connected to the first and second pixel electrodes, respectively, a third storage capacitor electrically connected to the first pixel electrode, and a connection electrode electrically connecting the third storage capacitor and the second storage capacitor; and a second substrate facing the first substrate and having a common electrode; and
a panel driver including a storage voltage supply unit supplying first and second storage voltages having phases inverted with respect to each other to the first and is second storage capacitors.

11. The LCD device of claim 10, wherein the first substrate comprises an organic passivation layer protecting the thin film transistor and an inorganic passivation layer formed between the thin film transistor and the organic passivation layer.

12. The LCD device of claim 11, wherein the third storage capacitor includes a storage electrode formed to overlap the first pixel electrode along the inorganic passivation layer disposed therebetween in an area where an opening for exposing an inorganic insulating layer penetrating the organic passivation layer is formed.

13. The LCD device of claim 12, wherein the storage electrode is electrically connected to the connection electrode.

14. The LCD device of claim 13, wherein the thin film transistor comprises a semiconductor layer overlapping the second storage line and formed between the data line and the connection electrode.

15. The LCD device of claim 14, wherein the common electrode comprises domain dividing means for dividing respective areas, in which the first and second pixel electrodes are formed, into a plurality of domains.

16. The LCD device of claim 15, wherein the second substrate comprises color filters formed corresponding to the first and second pixel electrodes.

17. The LCD device of claim 10, wherein the organic passivation layer comprises color filters for displaying colors according to the first and second pixel electrodes.

18. A method of driving a liquid crystal display device, comprising:
supplying a gate-on voltage to a gate line and a first data voltage to a data line so as to supply the first data voltage to a first pixel electrode connected to a thin film transistor;
charging the first data voltage to a third storage capacitor;
supplying a second data voltage charged in the third storage capacitor to a second pixel electrode;
supplying a first storage voltage to a first storage capacitor electrically connected to the first pixel electrode so as to shift the first data voltage; and
supplying a second storage voltage having a phase inverted with respect to the first storage voltage to a second storage capacitor electrically connected to the second pixel electrode so as to shift the second data voltage.

19. The method of claim 18, wherein supplying the second data voltage to the second pixel electrode comprises:
charging the first data voltage supplied to the first pixel electrode in the third storage capacitor; and
supplying the second data voltage, having a level between the first data voltage and a voltage charged in a liquid crystal capacitor, formed between the second pixel electrode and a common electrode and connected to the third storage capacitor in series, to the second pixel electrode.
